(19) United States
(12) Patent Application Publication
(10) Pub. No.: US 2025/0228736 A1
(43) Pub. Date: Jul. 17, 2025

(54) EMDR THERAPY SYSTEM

(71) Applicant: Noam EVE, Atlit (IL)

(72) Inventor: Noam EVE, Atlit (IL)

(21) Appl. No.: 18/764,215

(22) Filed: Jul. 4, 2024

(30) Foreign Application Priority Data
Jan. 17, 2024 (IL) 310222

(51) Int. Cl. A61H 23/00

(52) U.S. Cl. CPC A61H 23/006; A61H 2201/0157; A61H 2201/1638; A61H 2201/501; A61H 2201/5043; A61H 2201/5048; A61H 2201/5097

(57) ABSTRACT

An EMDR therapy system having one or more bilateral stimulation devices, an application program executed on a computer for activating a stimulation of the bilateral stimulation device, an input device through which a patient provides his distressing mood rating to the system before and after each treatment session, and computer code for determining characteristics of the stimulation for a next treatment session, according to past ratings of the patient.

### FIELD

The invention relates generally to the field of EMDR therapy.

### BACKGROUND

Eye movement desensitization and reprocessing (EMDR) is a form of psychotherapy that is controversial within the psychological community. It was devised by Francine Shapiro in 1987 and originally designed to alleviate the distress associated with traumatic memories such as post-traumatic stress disorder (PTSD).

EMDR involves focusing on traumatic memories in a manner similar to exposure therapy while engaging in side-to-side eye movements or other forms of bilateral stimulation. It is also used for some other psychological conditions. (From Wikipedia, EMDR)

From a practical point of view, this means bilateral (i.e., two-sided) stimulation of the eyes using an object that moves alternately from right to left and back while the patient follows the object with his eyes. During the treatment session, the patient brings up in his memory pictures from situations in the past that caused him distressing mood such as trauma, anxiety, stress, fear, and so on. Such treatment session lasts for example about two minutes, and performed usually three times a day. The patient is asked before and after the treatment session to rate his distressing mood. It turns out that in most cases there is indeed a change for the better.

A treatment may comprise several meetings, wherein each meeting comprises one or more treatment sessions.

Without going into the mechanism by which the bilateral stimulation acts on the brain, it should be noted that the stimulation helps to bypass the brain's defense mechanisms, thus making it possible to overcome a distressing mood such as post-trauma, anxiety, anger, failure, etc.

In addition to or as alternative for the bilateral stimulation through eyes, it is possible to activate another bilateral stimulation such as vibration acting alternately on each of the hands, once on the right hand and once on the left hand. It is also possible to use sounds once on the right and once on the left, tapping (the patient taps on his body once on the right side and once on the left) can also be useful.

In prior art, EMDR treatments are performed by a physician. However, as a result of a war or other mass disasters, the amount of personnel trained in EMDR therapy may be insufficient, and as such it is required an automated device for EMDR treating. Furthermore, a self-operated EMDR system may un-necessitate the need to reach to a clinic three times a day, so the patient can perform the EMDR treatment sessions at home.

### SUMMARY

In one aspect, the invention is directed to an EMDR therapy system, comprising one or more bilateral stimulation devices, an application program executed on a computer, for activating a stimulation of the bilateral stimulation device, an input device through which a patient provides his distressing mood rating to the system before and after each treatment session, and computer code for determining characteristics of the stimulation for a next treatment session, according to past ratings of the patient.

According to one embodiment of the invention, the bilateral stimulation devices are operated simultaneously.

According to one embodiment of the invention, the computer is local, thereby keeping information of the patient local.

According to another embodiment of the invention, the computer is remote, thereby allowing multiple patients to use the bilateral stimulation devices.

According to one embodiment of the invention, one of the stimulation devices stimulates a sight sense of the patient.

According to one embodiment of the invention, one of the stimulation devices stimulates a touch sense of the patient.

According to one embodiment of the invention, one of the stimulation devices stimulates a hearing sense of the patient.

According to one embodiment of the invention, the input device is a physical keyboard, or a virtual keyboard.

According to one embodiment of the invention, the input device is a microphone through which a user reads his input, and a speech-to-text converter, for converting the input into text.

In another aspect, the invention is directed to a method for determining a stimulation type of an EMDR treatment, comprising the steps of:
(a) rating by a patient his distressing mood;
(b) for the sight sense, touch sense, hearing sense, and combinations thereof, performing a bilateral stimulation of the group member of the patient, for a time period; and thereafter re-rating by the patient his distressing mood; and
(c) determining a sense or a combination of senses according to a best improvement determined by the ratings, for next treatment sessions.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Embodiments, features, and aspects of the invention are described herein in conjunction with the following drawings, in which:

FIG. 1 pictorially illustrates a back view of a patient using an EMDR system, according to one embodiment of the invention;

FIG. 2 pictorially illustrates a front view of a patient using an EMDR system, according to one embodiment of the invention;

FIG. 3 is a block diagram schematically illustrating an EMDR therapy system, according to one embodiment of the invention;

FIG. 4 is a block diagram schematically illustrating an EMDR therapy system, according to another embodiment of the invention; and

FIGS. 5a and 5b pictorially illustrate a vibrating element 14b, according to one embodiment of the invention, where FIG. 5a is a top view thereof, and FIG. 5b is a bottom view thereof.

It should be understood that the drawings are not necessarily drawn to scale.

### DETAILED DESCRIPTION

The invention will be understood from the following detailed description of embodiments which are meant to be descriptive and not limiting. For the sake of brevity, some well-known features, methods, systems, procedures, components, circuits, and so on, are not described in detail.

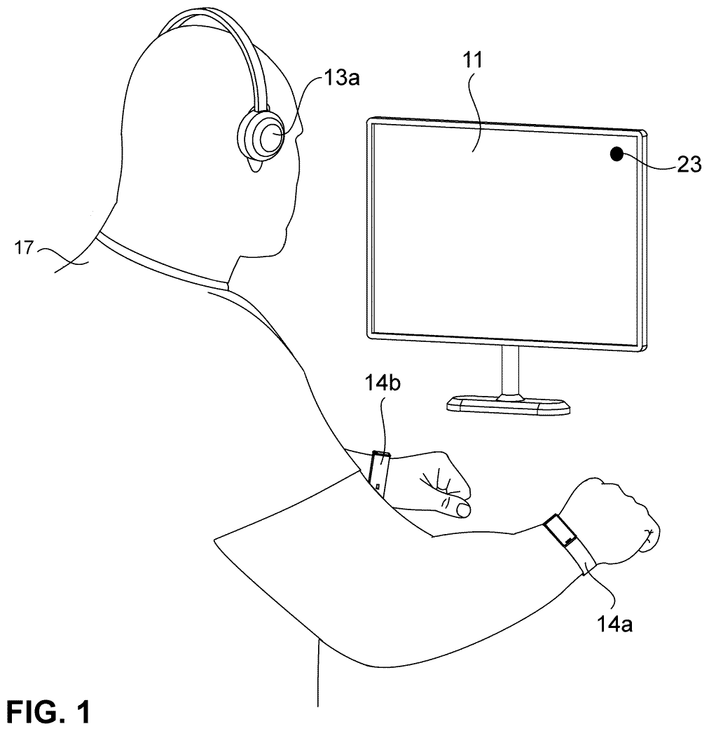

FIG. 1 pictorially illustrates a back view of a patient using an EMDR system, according to one embodiment of the invention.

The patient is looking at a computer screen 11. On the computer (not shown in this figure) runs an application that activates several bilateral stimuli simultaneously.

One of the bilateral stimuli is object 23 displayed on screen 11. The object (for example a circle) moves horizontally from one side of the screen to the other and back, alternately, according to the instructions of the application. The patient follows the movement of the object with his eyes. During the follow-up, the patient brings up in his memory images from a situation in the past that caused him trauma, anxiety, anger, depression, and so on. Such a treatment session usually lasts about two minutes. The patient is asked before and after the bilateral stimulation to rate his distressing mood (anxiety, anger, depression, etc.). It turns out that in most cases there is indeed a change for the better.

In additionally or alternatively, the patient wears a vibrating bracelet 14a, and 14b, on each hand. The bracelets vibrate alternately, once in one side, and next in the other side, at a rate set by the application, correspondingly with the moving object on the screen. Thus, when object 23 on the screen 11 reaches to the left side, the left bracelet 14b vibrates, and when the object reaches to the right side, the right bracelet 14a vibrates. That is, the vibration is also a bilateral stimulus and the application directs it to work simultaneously with the visual stimulus.

Another bilateral stimulus is a sound. The application can play a sound once in the right speaker (or in the right earphone 13a) and once in the left speaker (or in the left earphone), respectively with other bilateral stimuli.

The stimuli can be spot or continuous. A spot stimulus means the stimulus appears once in the right side and once in the left side. A continuous stimulus is a stimulus that, as it increases in one side, it weakens in the other side. For example, the sound gradually moves to the right side and gradually weakens on the left side, and vice versa. The same goes for the visual stimulus. The visual object moves continuously from one side to the other.

As mentioned, if there are several bilateral stimuli, such as a visual stimulus and a vibration stimulus, they must be simultaneous, that is, when the right side is stimulated, both the visual object and the vibrating object of the right side are activated while the other is silent. This is possible thanks to the app that controls the stimuli.

If so, there are three types of stimulation that the system is able to perform: sight, hearing and touch.

Due to the control of the parameters, such as the duration of the stimulation, the speed, the intensity, and so on, the system makes it possible to carry out a study of the subject (for example, monitoring the activation of the stimuli in order to draw conclusions). It also allows adjustment for each patient, such as adjusting the form of vibration, the type of object moving on the screen, the speed of the object, the duration of the stimulation, and so on. For example, for one patient the visual stimulation has a better effect, and for another patient the tactile stimulation has a better effect.

The ability to do research is a new feature, not recognized in the prior art.

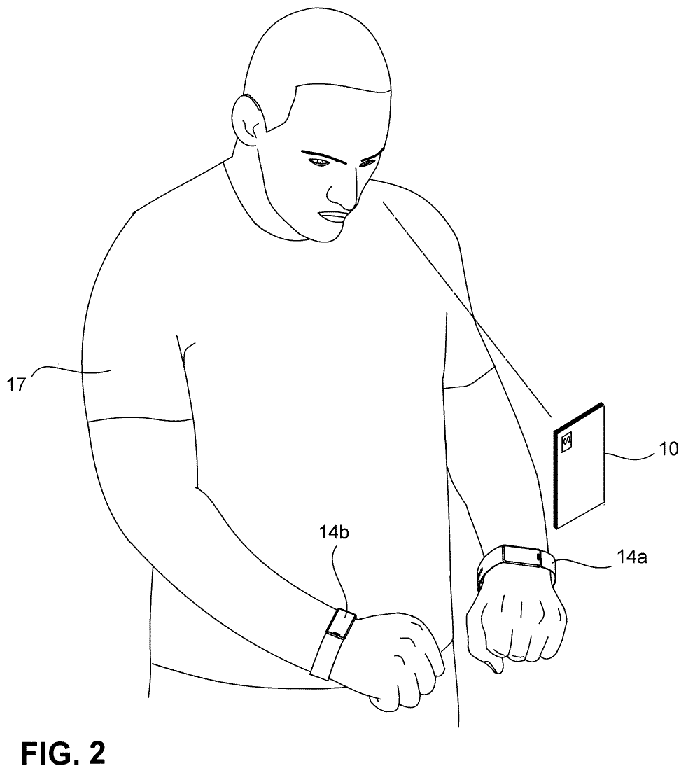

FIG. 2 pictorially illustrates a front view of a patient using an EMDR system, according to one embodiment of the invention.

It shows a patient 17 during a session of EMDR therapy. The patient wears two vibrating elements 14a, 14b on his hands, and looks at the portable cellular device 10 which is actually the computer.

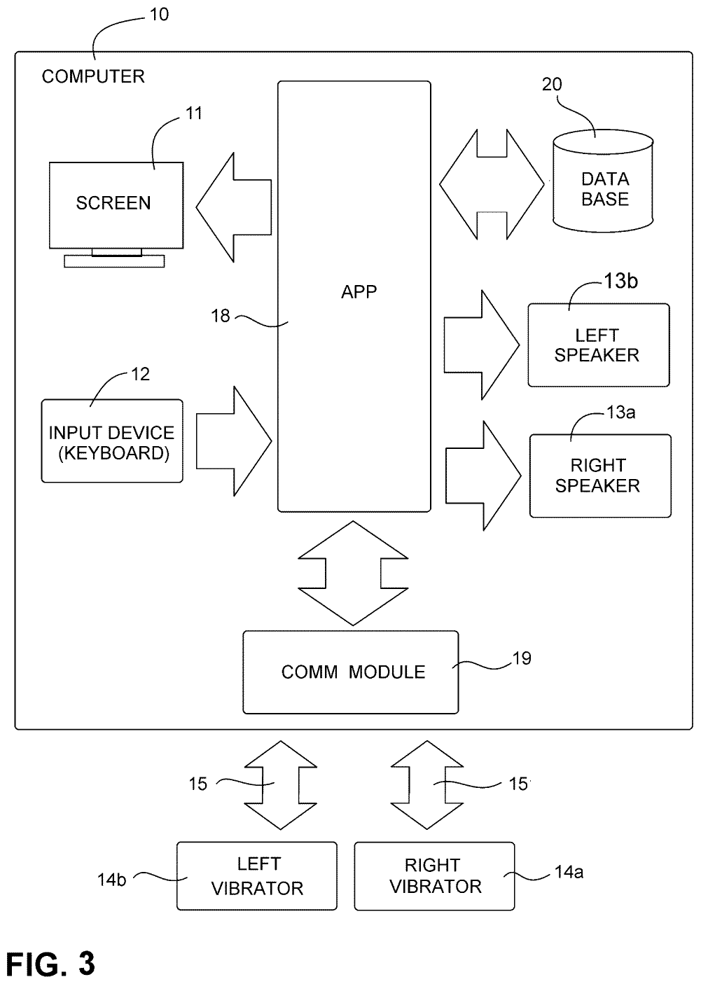

FIG. 3 is a block diagram schematically illustrating an EMDR therapy system, according to one embodiment of the invention.

The EMDR system has two major configurations: in the first configuration the application runs on the user's computer, in the second the application runs on a remote computer (server) and is in contact with the patient's computer via the Internet or other network.

It is possible to combine the two configurations, for example the application runs on the patient's computer, but the database resides on a remote computer (server) accessible to the user's computer via the Internet.

According to another configuration, the application runs on the remote computer, but the database is on the patient's computer. This configuration protects the patient's privacy as the database is accessible only from his computer.

According to the embodiment of the invention illustrated in FIG. 3, the application 18 and its database 20 reside on the user's computer 10.

The input means 12 to the application may be a keyboard, whether tangible or virtual. If the computer contains a microphone, the input may be vocal and is converted to text by Voice to Text technology, i.e. the user may answer to questions he is asked by speaking.

Speakers 13a, 13b (as an example of hearing sense stimulator) controlled by the application are intended for playing bilateral sounds (i.e., once on the right speaker and once on the left speaker) alternately.

The computer contains a screen 11 on which object 23 that moves from left to right and back is displayed. Questions for the patient (e.g., to grade his distressing mood), etc. are also displayed on the screen, or played on the computer's speaker(s) 13a, 13b.

The computer communicates through a communication module (software and hardware for connecting with another device) 19 with the two vibrating elements 14a, 14b for the purpose to activate and deactivate the vibration, in which form of work and which intensity, etc.

The vibration should be bilateral, that is, once in the right vibrating element 14a and once in the left vibrating element 14b, alternately, and simultaneously with other stimuli. Communication 15 of the computer 10 with the vibrating elements 14a, 14b can be wired or wireless, for example Bluetooth.

Patient details and his progress in the EMDR therapy are saved in database 20, for the purpose of determining the exercises of the next session.

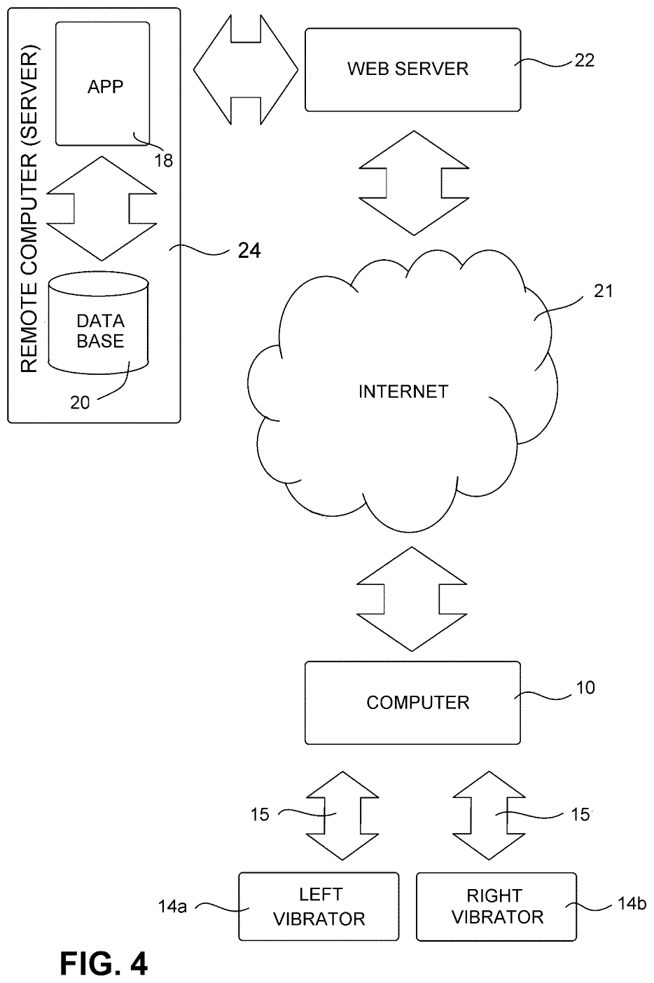

FIG. 4 is a block diagram schematically illustrating an EMDR therapy system, according to another embodiment of the invention.

According to this embodiment of the invention, the application 18 runs on a remote computer (i.e., server) 24 (which can also be the web server 22). The database 20 is accessible to the application 18. The application on the remote computer sends the user's computer 10 instructions such as activating the bilateral stimulation intermittently. The user's input arrives via the Internet 21 to the remote computer.

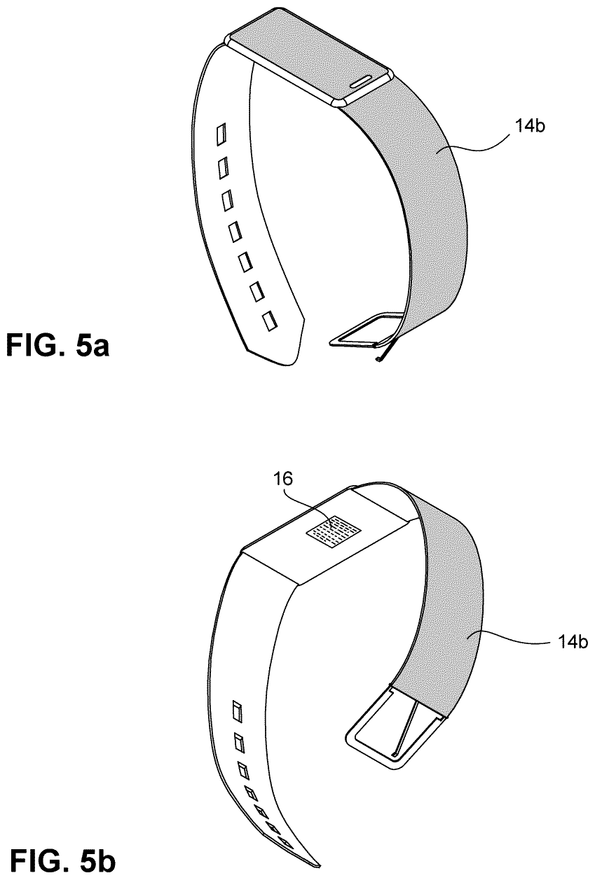

FIGS. 5a and 5b pictorially illustrate a vibrating element 14b, according to one embodiment of the invention. FIG. 5a is a top view thereof, and FIG. 5b is a bottom view thereof.

The vibrating element 14b is in a form of a wristwatch. The vibrating element comprises a QR-code notation 16, or other notation. The notation 16 may bear information such as a serial number of the bracelet, whether it is for right or left hand, a link to the application on the user computer so that the application is activated automatically, a link to the remote computer (server) application, etc.

The serial number may be associated with a patient identity. By associating a serial number to a hardware piece of the EMDR therapy system, only this patient can use the piece of hardware at a given period of time, and thereby ensuring the rights of the distributer of the system.

If the serial number is encoded, it ensures that no one can duplicate the hardware piece for using the system “illegally”.

Of course, the application may be designed to allow multiple patients to use the system at a time period, by asking the patient to identify himself before each treatment session.

One aspect of the invention is the ability to find out which of the senses or combination of senses has the best effect on the patient, and accordingly limit the stimuli in the treatment to these senses or their combination.

Defining to the system which senses should be tested (sight, hearing, touch), and activating a stimuli session for each of the senses and their combination.

The sense(s) to be selected are these which are the most effective according to the difference between the rating before and after the stimuli session.

In the figures and/or description herein, the following reference numerals (Reference Signs List) have been mentioned:
numeral 10 denotes a computer, such as a desktop computer, smartphone, tablet computer;
numeral 11 denotes a sight sense stimulator, such as a computer screen;
numeral 12 denotes computer input means, such as keyboard, virtual keyboard, microphone and Speech-To-Text converter, etc.;
numerals 13a and 13b denotes a right and left hearing stimulator, such as speaker, headphone, etc.;
numeral 14a and 14b denote a right and left touch stimulator, such as vibrator;
numeral 15 denotes communication, such as carried out via Bluetooth;
numeral 16 denote a code notation, such as a code notation such as QR-code, barcode, etc.;
numeral 17 denotes a patient;
numeral 18 denotes a computer application program;
numeral 19 denotes a communication module of a computer;
numeral 20 denotes a database;
numeral 21 denotes the Internet as an example of data network;
numeral 22 denotes a web server;
numeral 23 denotes a sight stimulation object; and
numeral 24 denotes a remote computer (i.e., remote server).

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. An EMDR therapy system, comprising:
one or more bilateral stimulation devices;
an application program executed on a computer, for activating a stimulation of said bilateral stimulation device;
an input device through which a patient provides his distressing mood rating to said system before and after each treatment session;
computer code for determining characteristics of said stimulation for a next treatment session, according to past ratings of said patient.

2. The system according to claim 1, wherein said bilateral stimulation devices are operated simultaneously.

3. The system according to claim 1, wherein said computer is local, thereby keeping information of said patient local.

4. The system according to claim 1, wherein said computer is remote, thereby allowing multiple patients to use said bilateral stimulation devices.

5. The system according to claim 1, wherein one of said stimulation devices stimulates a sight sense of said patient.

6. The system according to claim 1, wherein one of said stimulation devices stimulates a touch sense of said patient.

7. The system according to claim 1, wherein one of said stimulation devices stimulates a hearing sense of said patient.

8. The system according to claim 1, wherein said input device is a physical keyboard, or a virtual keyboard.

9. The system according to claim 1, wherein said input device is a microphone through which a user reads his input, and a speech-to-text converter, for converting said input into text.

10. A method for determining a stimulation type of an EMDR treatment, comprising the steps of:
(a) rating by a patient his distressing mood;
(b) for each member selected from a group consisting of: sight sense, touch sense, hearing sense, and combinations thereof, performing a bilateral stimulation of said group member of said patient, for a time period; and thereafter re-rating by said patient his distressing mood; and
(c) determining a sense or a combination of senses according to a best improvement determined by the ratings, for next treatment sessions.
